(19) United States
(12) Patent Application Publication
(10) Pub. No.: US 2010/0231716 A1
(43) Pub. Date: Sep. 16, 2010

(54) Vehicle-Mountable Imaging Systems and Methods

(76) Inventors: Mark A. Klaerner, Round Rock, TX (US); Danny L. Plemons, Austin, TX (US); Allister McNeish, Austin, TX (US); C. Rodger Claycomb, JR., Pflugerville, TX (US); David K. Breakfield, Austin, TX (US)

Correspondence Address: BAE SYSTEMS, PO BOX 868, NASHUA, NH, 03061-0868, US

(21) Appl. No.: 12/404,177

(22) Filed: Mar. 13, 2009

(51) Int. Cl. H04N 7/18; F21V 33/00; H01L 25/00

(52) U.S. Cl. 348/148; 362/234; 250/332; 348/E07.085

(57) ABSTRACT

Imaging systems, methods, and vehicles having imaging systems.

### BACKGROUND OF THE INVENTION

1. Field of the Invention

The present invention relates generally to situational awareness (SA) sensors, and, more particularly, but not by way of limitation, to situational awareness sensors configured for use with vehicles such as military vehicles.

2. Description of Related Art

A number of situational awareness devices and systems have been developed and/or are in use in the art, such as, for example, the Check-6™ system manufactured by BAE Systems, which has numerous offices and other facilities in the United States and worldwide.

Existing systems typically use a “federated box” approach to adding additional tools, such as sensors, to a platform. In this approach, these additional tools are merely added to the existing volume of the vehicle or previous appendages, and thereby further increase the overall volume of the vehicle. This can result in an appendage on the vehicle that looks like a target of opportunity and can attract the attention of an enemy.

The following reference may include an example or examples of situational-awareness devices and systems, and may facilitate an understanding of background information and possible application-specific information for this and related fields of endeavor: International Application No. PCT/US2007/008070, filed Apr. 3, 2007, and published as WO 2008/048370, which is incorporated by reference in its entirety.

### SUMMARY OF THE INVENTION

The present disclosure includes various embodiments of imaging systems, methods, and vehicles having imaging systems.

Some embodiments of the present imaging systems are suitable for use with, configured for use with, or otherwise usable with a vehicle.

Some embodiments comprise: a first imaging sensor; a second imaging sensor; and a housing coupled to the first imaging sensor and the second imaging sensor, the housing configured to be connected to a vehicle without permanently modifying the vehicle. In some embodiments, the first imaging sensor is a long-wavelength infrared (LWIR) sensor. In some embodiments, the second imaging sensor is a visible near-infrared (VNIR) sensor. In some embodiments, the vehicle is selected from the group consisting of: M1117 Guardian Armored Security Vehicles (ASVs), High Mobility Multipurpose Wheeled Vehicles (Humvee), Family of Medium Tactical Vehicles (FMTV), Light Medium Tactical Vehicles (LMTV), Medium Tactical Vehicles (MTV), Medium Tactical Vehicle Replacements (MTVR), Heavy Expanded Mobility Tactical Trucks (HEMTT), Heavy Equipment Transport Systems (HETS), Palletized Load System (PLS) vehicles, and Bradley Fighting Vehicles.

Some embodiments of the present imaging systems comprise: an image-fusion board coupled to the first imaging sensor and the second imaging sensor, the image-fusion board configured to fuse images from the first imaging sensor with images from the second imaging sensor.

Some embodiments of the present imaging systems comprise: a plurality of light-emitting diodes (LEDs) coupled to the housing. In some embodiments, the LEDs emit visible amber-colored light.

Some embodiments of the present imaging systems comprise: a blackout driving light coupled to the housing. Some embodiments comprise: a display configured to be coupled to the image-fusion board such that the display can receive and display fused images from the image-fusion board.

Some embodiments of the present imaging systems comprise: an input device coupled to the image-fusion board, and configured to be operable by a user to adjust the intensity of images from the first imaging sensor relative to the intensity of images from the second imaging sensor in the fused images. In some embodiments, the input device is physically coupled to the display.

Some embodiments of the present imaging systems comprise: a central interface module (CIM) configured to be coupled to the image-fusion board and to the display such that fused images can be transmitted from the image-fusion board to the display via the CIM. In some embodiments, the central interface module (CIM) is configured to be coupled to one or more additional imaging devices such that images can be transmitted from the one or more additional imaging devices to the display via the CIM.

Some embodiments of the present imaging systems comprise: a long-wavelength infrared (LWIR) sensor configured to detect one or more infrared wavelengths of light; a visible near-infrared (VNIR) sensor; a near-infrared illuminator configured to emit one or more infrared wavelengths of light that correspond to the one or more infrared wavelengths of light the VNIR sensor can detect; and a housing coupled to the first imaging sensor, the second imaging sensor, and the near-infrared illuminator, the housing configured to be connected to a vehicle. In some embodiments, the near-infrared illuminator comprises a plurality of light-emitting diodes (LEDs). In some embodiments, the LEDs of the near-infrared illuminator emit only non-visible light.

Some embodiments of the present imaging systems comprise: a long-wavelength infrared (LWIR) sensor; a visible near-infrared (VNIR) sensor; a plurality of light-emitting diodes (LEDs); a housing coupled to the LWIR sensor, the VNIR sensor, and the plurality of LEDs, the housing configured to be connected to a vehicle. Some embodiments further comprise a blackout driving light coupled to the housing. Some embodiments further comprise: an image-fusion board coupled to the LWIR sensor and the VNIR sensor, and configured to fuse images from each of the LWIR sensor and the VNIR sensor.

Some embodiments of the present imaging systems comprise: a long-wavelength infrared (LWIR) sensor; a visible near-infrared (VNIR) sensor; and a housing coupled to the LWIR sensor and the VNIR sensor; where one of the LWIR sensor and VNIR sensor is coupled to the housing in fixed relation to the housing, and where the other of the LWIR sensor and VNIR sensor is adjustably coupled to the housing. Some embodiments further comprise: an adjustment mechanism coupled to each of the housing and the adjustably-coupled one of the LWIR sensor and VNIR sensor such that the adjustably-coupled one of the LWIR sensor and VNIR sensor is coupled to the housing via the adjustment mechanism, the adjustment mechanism configured to permit adjustment of the position of the adjustably-coupled one of the LWIR sensor and VNIR sensor relative to the housing. In some embodiments, the adjustment mechanism comprises: a pivot plate coupled to the adjustably-coupled one of the LWIR sensor and VNIR sensor; a plurality of adjustment posts, each coupled to the housing and to the adjustment plate; where the pivot plate and adjustment posts are configured to permit a user to adjust the position of the pivot plate relative to one or more of the adjustment posts to adjust the position of the adjustably-coupled one of the LWIR sensor and VNIR sensor relative to the housing.

Some embodiments of the present vehicles comprise: a vehicle having a front axle; and an imaging system. In some embodiments, the imaging system comprises: a long-wavelength infrared (LWIR) sensor; and a visible near-infrared (VNIR) sensor. In some embodiments, the LWIR sensor and the VNIR sensor are coupled to the vehicle and disposed in front of the front axle of the vehicle.

Some embodiments of the present vehicles further comprise: an image-fusion board coupled to the LWIR sensor and the VNIR sensor, and configured to fuse images from each of the LWIR sensor and the VNIR sensor.

Some embodiments of the present vehicles comprise: a display coupled to the image-fusion board, and configured to receive fused images from the image-fusion board and to display the fused images in a format perceivable by a user.

In some embodiments of the present vehicles, the vehicle is selected from the group consisting of: M1117 Guardian Armored Security Vehicles (ASVs), High Mobility Multipurpose Wheeled Vehicles (Humvee), Family of Medium Tactical Vehicles (FMTV), Light Medium Tactical Vehicles (LMTV), Medium Tactical Vehicles (MTV), Medium Tactical Vehicle Replacements (MTVR), Heavy Expanded Mobility Tactical Trucks (HEMTT), Heavy Equipment Transport Systems (HETS), Palletized Load System (PLS) vehicles, and Bradley Fighting Vehicles.

Various embodiments of the present systems can be implemented with, coupled to, installed on, or otherwise used with various military vehicles, such as, for example, M1117 Guardian Armored Security Vehicles (ASVs), High Mobility Multipurpose Wheeled Vehicles (HMMWV or Humvee), Family of Medium Tactical Vehicles (FMTV), Light Medium Tactical Vehicles (LMTV), Medium Tactical Vehicles (MTV), Medium Tactical Vehicle Replacements (MTVR), Heavy Expanded Mobility Tactical Trucks (HEMTT), Heavy Equipment Transport Systems (HETS), Palletized Load System (PLS) vehicles, Bradley Fighting Vehicles (e.g., M2, M2A1, M2A2, M2A3, M3, M3A1, M3A2, M3A3, M6, M7, etc.).

Any embodiment of any of the present methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar flnctionality, as may non-identical reference numbers.

FIG. 1 depicts an embodiment of one of the present imaging systems shown mounted to a Humvee vehicle.

FIG. 2 depicts an enlarged view of one of the present imaging sensor modules shown mounted to a Humvee vehicle.

FIG. 3 depicts an enlarged view of one example of a position on a Humvee vehicle suitable for mounting one of the present imaging sensor modules.

FIG. 4 depicts one of the present imaging sensor modules shown mounted to a Bradley Fighting Vehicle.

FIG. 5 depicts an exploded view of an imaging sensor module suitable for use with embodiments of the present imaging systems, such as the embodiment of FIG. 1.

FIG. 6 depicts an enlarged front view of a portion of the imaging sensor module of FIG. 5.

FIG. 7 depicts exploded and assembled views of an adjustment mechanism for use with the imaging sensor module of FIG. 5.

FIG. 8 depicts a mounting member for connecting the imaging sensor module of FIG. 5 to a vehicle.

FIG. 9 depicts another embodiment of an imaging sensor module having a near infrared (IR) illuminator with examples of fields-of-view of the near-IR illuminator and a sensor.

FIG. 10 depicts perspective and exploded views of a central interface module suitable for embodiments of the present imaging systems, such as the embodiment of FIG. 1.

FIG. 11 depicts a front view of a display suitable for embodiments of the present imaging systems, such as the embodiment of FIG. 1.

FIG. 12 depicts an image from a visible near-infrared (VNIR) sensor, an image from a long-wavelength infrared (LWIR) sensor, and a fused image fused from the VNIR image and the LWIR image.

FIG. 13 depicts two exemplary mounting positions on a vehicle, such as a Humvee, for an imaging sensor module of embodiments of the present imaging systems.

FIGS. 14 and 15 depict possible field-of-view (FOV) configurations for embodiments of the present imaging systems in which the imaging sensor module(s) include two VNIR sensors.

### DESCRIPTION OF ILLUSTRATIVE EMBODIMENTS

The term “coupled” is defined as connected, although not necessarily directly, and not necessarily mechanically; two items that are “coupled” may be integral with each other. The terms “a” and “an” are defined as one or more unless this disclosure explicitly requires otherwise. The terms “substantially,” “approximately,” and “about” are defined as largely but not necessarily wholly what is specified, as understood by a person of ordinary skill in the art.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those elements. For example, in an imaging system that comprises an imaging sensor module and a display, the imaging system includes the specified elements but is not limited to having only those elements. For example, such an imaging system could also include a central interface module coupled to the imaging sensor module and the display, such that images are received by the display from the imaging sensor module via the central interface module. Likewise, a method that “comprises,” “has,” “includes” or “contains” one or more steps possesses those one or more steps, but is not limited to possessing only those one or more steps.

Further, a device or structure that is configured in a certain way is configured in at least that way, but it can also be configured in other ways than those specifically described. A device or structure that is configured to be or do something has the capacity to be or do that something but need not (though it may) actually be or do that something. For example, a device or structure that is configured to be connected in a certain way need not actually be connected.

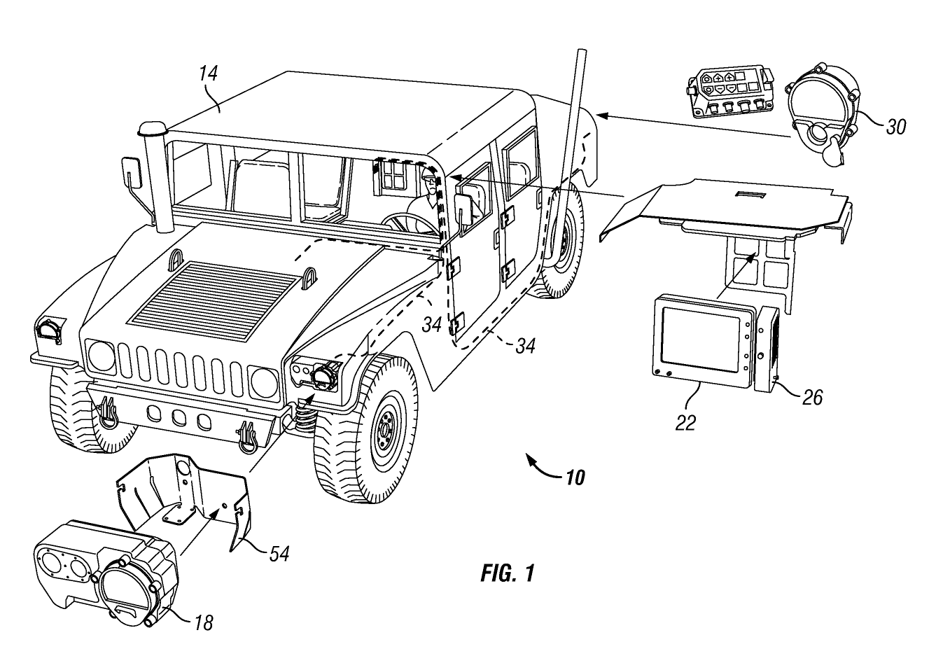

Referring now to the drawings, and more particularly to FIG. 1, shown therein and designated by the reference numeral 10 is an embodiment of one of the present imaging systems shown mounted to a Humvee vehicle 14. Imaging system 10 may be interchangeably referred to herein as system 10. In the embodiment shown, system 10 comprises an imaging sensor module (ISM) 18, a display 22, a central interface module (CIM) 26, and a rear imaging system 30. In the embodiment shown, system 10 also comprises a plurality of cables 34 coupling imaging sensor module 18, display 22, central interface module 26, and rear imaging sensor 30 to one another and to a power supply (not shown) such as, for example, the battery or another part of the electrical system of the vehicle 14. In some embodiments, imaging system 10 may be described as a vehicle-mountable imaging system.

The imaging sensor module 18 comprises one or more imaging sensors (e.g., video cameras), such as, for example, infrared (IR) imaging sensors, visible imaging sensors, long-wavelength infrared (LWIR) sensors, visible near-infrared (VNIR) imaging sensors, or the like. In some embodiments, the imaging sensors continuously detect light such that they continuously output images (e.g., “moving” images, which can be, for example, a continuously changing streamed image, continuously output sequential images, or the like). “Images” are not necessarily required to be of visible light. Instead, an “image” as used herein describes the result of the sensing or collection of light (e.g., visible, infrared, and/or other wavelengths) to identify landscape or, more generally, an item or items (e.g., surroundings, objects, people, animals, or the like) that are in the field-of-view of an imaging sensor.

Display 22 is configured to receive and display fused images from the imaging sensor module in a format perceivable by a user (e.g., a driver of vehicle 14). Central interface module 26 is configured to be coupled to imaging sensor module 18 and display 22 such that display 22 can receive images from imaging sensor module 18 via central interface module 26. In the embodiment shown, central interface module 26 is also configured to be coupled to one or more additional imaging devices (e.g., rear imaging sensor 30) such that images can be transmitted from the one or more additional imaging devices to the display via the CIM. In such an embodiment, the display and/or the central interface module can be configured such that a user can toggle or switch between receiving and/or viewing images from one or both of imaging sensor module 18 and from rear imaging device 30.

One example of a sensor for use as rear imaging sensor 30 is the Check-6™ system manufactured by BAE Systems, with locations and manufacturing facilities across the United States. The Check-6 system may also be described in the reference mentioned and incorporated by reference in the background section above.

Embodiments of imaging sensor modules, displays, and central interface modules that are suitable for use in system 10 are described below in more detail.

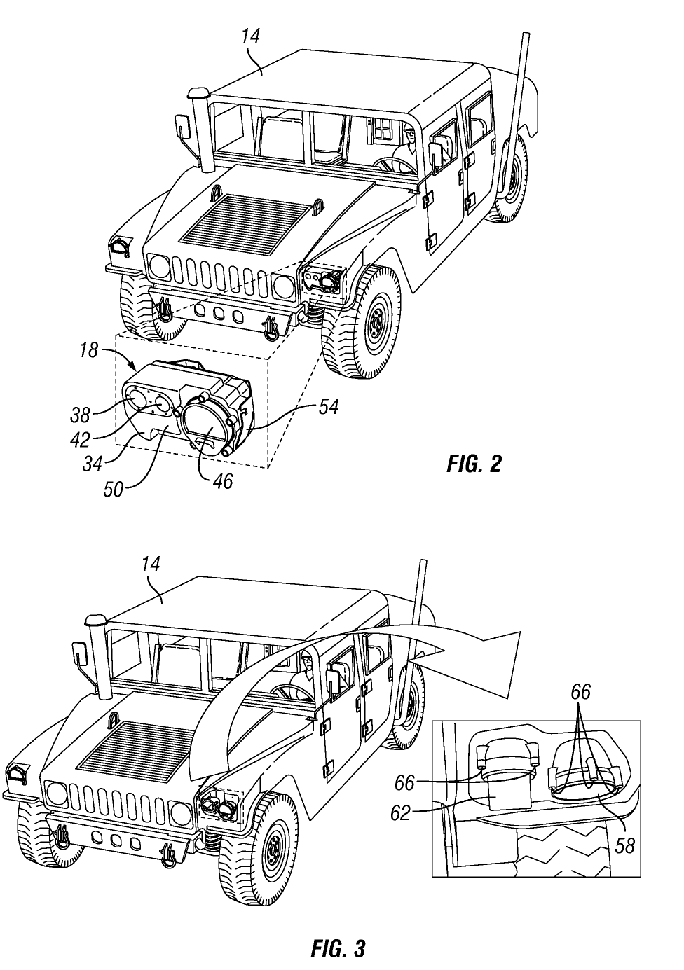

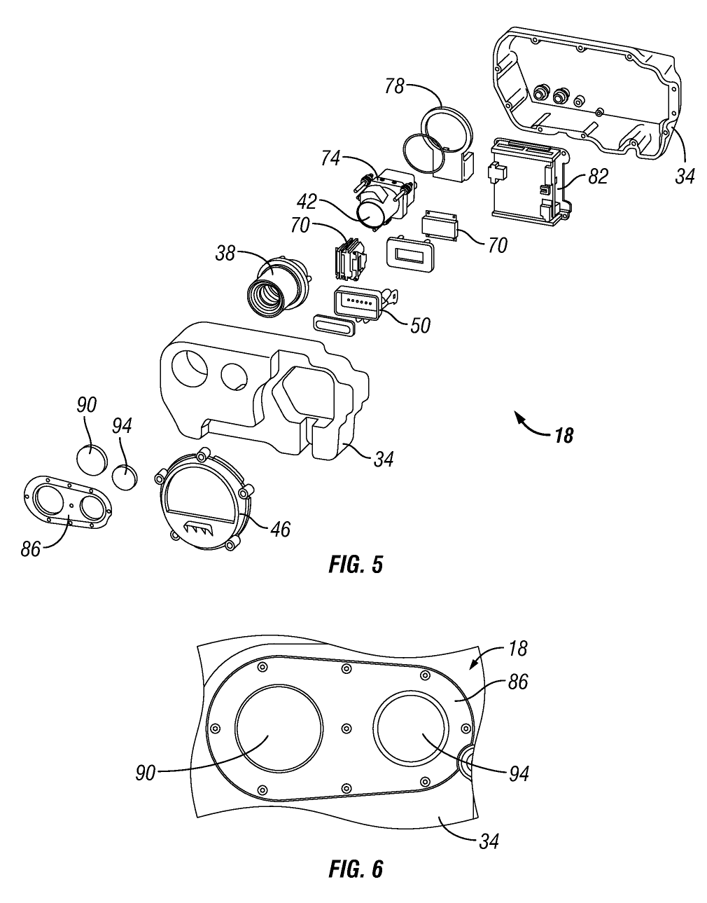

Referring now to FIG. 2, an enlarged view of one of the imaging sensor module 18 of FIG. 1 is shown mounted to a Humvee vehicle 18. In the embodiment shown, imaging sensor module 18 comprises a housing 34, a first imaging sensor 38, a second imaging sensor 42, a marker light 46, and a blackout driving light 50 (see also FIG. 5). In the embodiment shown, marker light 46 comprises a plurality of light-emitting diodes (LEDs) configured to emit amber-colored visible light. In other embodiments, the marker light can comprise any suitable light source and/or can be configured to emit any suitable color of light (e.g., red, blue, green, or others). In the embodiment shown, blackout driving light 50 comprises one or more light-emitting diodes (LEDs). In other embodiments, one or both of marker light 46 and blackout driving light 50 can be supplemented, substituted, or omitted.

In the embodiment shown, housing 34 is configured to be connected to vehicle 14 without permanently modifying the vehicle. More specifically, in the embodiment shown, imaging sensor module 18 comprises a mounting member 54 coupled to the housing 34 such that housing 34 is configured to be connected (and, here, is shown actually connected) to vehicle 14 by way of mounting member 54. For example, mounting member 54 can be provided with two or more holes, one or more pins and one or more holes, or the like (not shown) that can be aligned with existing screw holes or other holes on the vehicle, such that the mounting member can be secured to the vehicle with one or more screws, and without permanently modifying the vehicle.

As used herein, “without permanently modifying the vehicle” does not mean that the vehicle is not modified at all, or that the vehicle is eventually returned to its original state. Instead, “without permanently modifying the vehicle” means that the vehicle is not modified so drastically that it cannot be returned to its original state without extensive work. For example, removing existing lights by removing screws from existing screw holes is not permanently modifying the vehicle, even if the light is never re-attached, because the light could be re-attached by simply re-positioning the lights and using screws to re-attach the lights via the existing screw holes. Conversely, if after the light were removed, additional holes were drilled in the vehicle, this would be “permanently modifying” the vehicle, because the vehicle could not be returned to its original state (i.e., the holes could not be removed) without extensive work such as welding or the like.

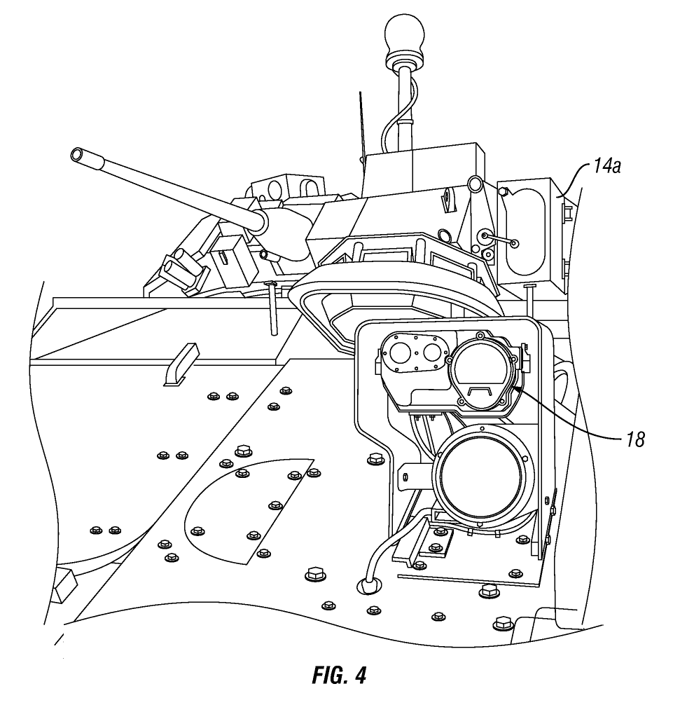

Referring now to FIG. 3, an enlarged view is shown of one example of a position on a Humvee vehicle 14 suitable for mounting one of the present imaging sensor modules 18. The vehicle shown includes a marker light 58 and a blackout driving light 62 connected to the vehicle by way of screws 66 that are threaded into corresponding screw holes. When screws 66, and marker light 58 and blackout driving light 62, are removed, the corresponding screw holes are emptied such that the imaging sensor module 18 can be connected to the vehicle without permanently modifying the vehicle. The Humvee 14 shown is just one example of a vehicle to which the imaging sensor module 18 (e.g., housing 34 and/or mounting member 54) can be mounted without permanently modifying the vehicle. For example, and as shown in FIG. 4, imaging sensor module 18 can be (and is) configured to be connected to a Bradley Fighting Vehicle 14a.

Referring now to FIGS. 5 and 6, FIG. 5 depicts an exploded view of the imaging sensor module 18 suitable for use with system 10 of FIG. 1, and FIG. 6 depicts an enlarged front view of a portion of the imaging sensor module. As described above, imaging sensor module 18 comprises a housing 34, first imaging sensor 38, a second imaging sensor 42, a marker light 46, and a blackout driving light 50. In the embodiment shown, marker light 46 comprises a plurality of light-emitting diodes configured to emit amber-colored visible light. In the embodiment shown, the imaging sensor module 18 further comprises one or more circuit card assemblies 70, an adjustment mechanism 74, a mounting bracket 78, an image-fusion board 82, a faceplate 86, a first lens 90, a second lens 94, and one or more connectors 98. Housing 34 can comprise any suitably durable material, such as, for example, 6061 Aluminum, 7068 Aluminum, 7075 Aluminum, polymer, steel, alloy, composite, or the like. In some embodiments, when the imaging sensor module is assembled, housing 34 is hermetically sealed.

In the embodiment shown, first imaging sensor 38 is an infrared (IR) sensor, and more specifically, is a long-wavelength infrared (LWIR) sensor. One example. of a suitable LWIR sensor is the MIM500X infrared sensor (camera) manufactured by BAE Systems, with offices and manufacturing facilities across the United States. In some embodiments, the LWIR sensor includes a hard carbon-coated germanium, f1.0 lens (or lens set) having a 40° field of view. In some embodiments, the LWIR sensor includes a 640×480 pixel, un-cooled, micro-bolometer detector with a spectral range of 8-14.5 μm spectral range. In the embodiment shown, first imaging sensor 38 is coupled in fixed relation to housing 34 by screws. One or more circuit card assemblies 70 are optically and/or electrically coupled to the LWIR sensor and or the VNIR sensor, and are configured to process images from one or both of the sensors, control the micro-bolometer of the LWIR sensor, condition the incoming voltage/current from a power source to one or both of the sensors, and/or perform analogue-to-digital and/or digital-to-analogue conversion of signals to or from one or both of the sensors. Examples of a suitable circuit card assemblies (CCAs) are the Casper II CCA, manufactured by BAE Systems for the MIM500X LWIR camera. Other suitable IR sensors (e.g., cameras) and CCAs are available from FLIR Systems, in Goleta Calif. Mounting bracket 78 is connected to LWIR sensor 38 and housing 34 by way of screws, such that mounting bracket 78 physically supports at least one circuit card assembly 70. In the embodiment shown, mounting bracket 78 connects to at least one circuit card assembly 70 by way of wedge locks. In other embodiments, the mounting bracket can be connected to the sensor and/or one or more circuit card assemblies by any suitable means, such as, for example, screws, rivets, adhesive, or the like.

In the embodiment shown, second imaging sensor 42 is a visible sensor (camera), and more specifically, is a commercial off-the-shelf (COTS) visible near-infrared (VNIR) camera. For example, the VNIR sensor can be a ruggedized COTS VNIR camera. In some embodiments, the VNIR sensor has automatic shutter control and/or a good quantum efficiency (QE) at wavelengths of up to 905 nanometers (nm). In some embodiments, the VNIR sensor includes an f1.4 lens (or lens set) having a 40° field-of-view (FOV). In the embodiment shown, the second imaging sensor 42 is coupled in adjustable relation to housing 34 by way of adjustment mechanism 74. The adjustment mechanism is configured to permit adjustment of the position of the second imaging sensor relative to the housing, as is described in more detail below.

Image-fusion board 82 is coupled to the first (e.g., LWIR) imaging sensor and the second (e.g., VNIR) imaging sensor. The image-fusion board is configured to receive images from each of the two sensors and to fuse images from the first imaging sensor with images from the second imaging sensor, such that, for example, the first images and second images are unified into fused images (e.g., fused video images). In the embodiment shown, the image-fusion board is configured to scale one or both of the images from the VNIR sensor and images from the LWIR sensor, such that the images share a common scale prior to fusing them into fused images. In the embodiment shown, the image-fusion board is also configured to de-warp one or both of the images from the VNIR sensor and images from the LWIR sensor, such that the images share a common shape prior to fusing the images into fused images. In the embodiment shown, the image-fusion board is configured to receive the images in a digital format and to fuse the VNIR image and LWIR images on a pixel-by-pixel level. In other embodiments, the image-fusion board can be configured to receive the images in analogue format and to convert the images to digital format prior to fusing them. In the embodiment shown, the image-fusion board is also configured to output the fused images in both analogue and digital video formats. In other embodiments, the image-fusion board can be configured to output analogue and/or digital video and/or still images.

In the embodiment shown, the image-fusion board is also configured to adjust the intensity of images from the first imaging sensor relative to the intensity of images from the second imaging sensor in the fused images, such as, for example, in response to an input from a user. Stated another way, the image-fusion board is configured to adjust (e.g., in response to user input) the output fused images between one extreme of 100% LWIR images and 0% VNIR images (100:0), and the other extreme of 0% LWIR images and 100% VNIR images (0:100), and/or various relative intensities between these two extremes, such as, for example, one of, or range between, any of about: 100:0, 95:5, 90:10, 85:15, 80:20, 75:25, 70:30, 65:35, 60:40, 55:45, 50:50, 45:55, 40:60, 35:65, 30:70, 25:75, 20:80, 15:85, 10:90, 5:95, and 0:100. In some embodiments, the image-fusion board can be configured such that it can only adjust the relative intensities between discrete points or ranges between the points listed above.

In the embodiment shown, faceplate 86 is removably connected to housing 34 by screws such that faceplate 86 can be removed and, such as, for example, to clean and/or replace first and second lenses 90 and 94. The faceplate can also be configured to support first and second lenses 90 and 94. In the embodiment shown, and as mentioned above, first lens 90 (corresponding to LWIR sensor 38) comprises hard carbon-coated germanium, and second lens 94 (corresponding to VNIR sensor 42) comprises indium-tin oxide (ITO)-coated sapphire with anti-reflective coatings on its front and/or rear surfaces. In some embodiments, the first and second lenses are connected to the faceplate, such that the faceplate and lenses can be replaced as a unit.

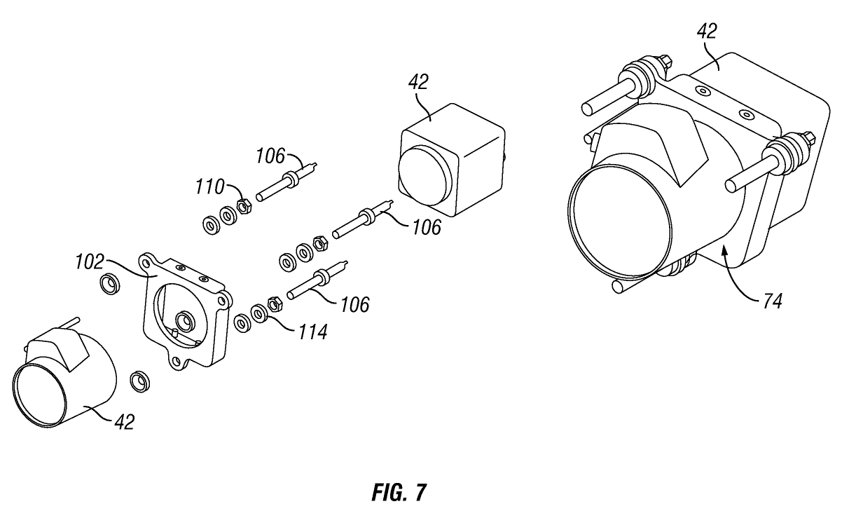

Referring now to FIG. 7, enlarged and exploded views are shown of adjustment mechanism 74 of imaging sensor module 18 of FIG. 5. As mentioned above, in the embodiment of imaging sensor module 18 shown in FIG. 5, VNIR sensor 42 is coupled to housing 34 by way of adjustment mechanism 74. In order to improve the accuracy of fusing the images from the LWIR sensor and images from the VNIR sensor, the respective fields-of-view of the LWIR sensor and VNIR sensor can be substantially aligned (e.g., longitudinal axes through respective centers and focal points of each lens are substantially parallel). With the LWIR sensor connected in fixed relation to the housing, and the VNIR sensor adjustably coupled to the housing via adjustment mechanism 74, adjustment mechanism 74 is configured to permit adjustment of the position of the VNIR sensor relative to the housing, such that the field-of-view of the VNIR sensor can be substantially aligned with the field-of-view of the LWIR sensor.

In the embodiment shown, adjustment mechanism 74 comprises an adjustment plate 102 and a plurality of adjustment posts 106. Adjustment plate 102 is coupled in fixed relation to the VNIR sensor by screws 104, and each adjustment post 106 is coupled to adjustment plate 102 and to housing 34. The pivot plate and adjustment posts are configured to permit a user to adjust the position of the pivot plate relative to one or more of the adjustment posts to adjust the position of the VNIR sensor relative to the housing. More specifically, in the embodiment shown, the adjustment posts are coupled in longitudinally-fixed relation to the adjustment plate, and are coupled in adjustable relation to the housing. A threaded portion of each adjustment post is coupled in longitudinally-fixed relation to the adjustment plate by way of nuts 110 and washers 114. Washers 114 can comprise spherical washers to facilitate angular motion of the adjustment plate relative to the respective adjustment post while limiting or substantially preventing binding, pinching, or the like. In some embodiments, washers 114 can comprise a resilient material, such as, for example, rubber, polyurethane, neoprene, or the like, to reduce shock and vibration transmitted to the VNIR sensor. A threaded portion of each adjustment post 106 is adjustably coupled to the housing by way of threaded holes, such that the position of the VNIR sensor can be adjusted by rotating one or more of the adjustment posts relative to the housing. The accuracy with which the position of the VNIR sensor can be increased by decreasing the pitch of the threaded portion.

In one method of aligning the VNIR sensor and LWIR sensor, both sensors and the adjustment mechanism are coupled to at least a portion of the housing (e.g., a front portion of the housing); the (fixed) LWIR sensor is centered on a target approximately 40 feet from the ISM that is visible in both the IR and visible spectrums; the VNIR sensor is activated; images from both the LWIR sensor and the VNIR sensor are viewed on a monitor the horizontal and vertical alignments recorded; any horizontal and vertical differences between the observed spacing on the monitor are correlated to the physical spacing in the housing; and the VNIR sensor is adjusted by rotating any combination of the three elevation adjustment screws until the spacing is within a desired or required tolerance. In some embodiments, the adjustment mechanism is configured such that the alignment of the VNIR sensor relative to the LWIR sensor can be accurately adjusted to within one-half (½) of a pixel of the LWIR sensor. The adjustment mechanism may also be referred to as a fine-tilt adjustment mechanism (FTAM).

In other embodiments, the first imaging sensor can be coupled in adjustable relation to the housing, and the second imaging sensor can be coupled in fixed relation to the housing.

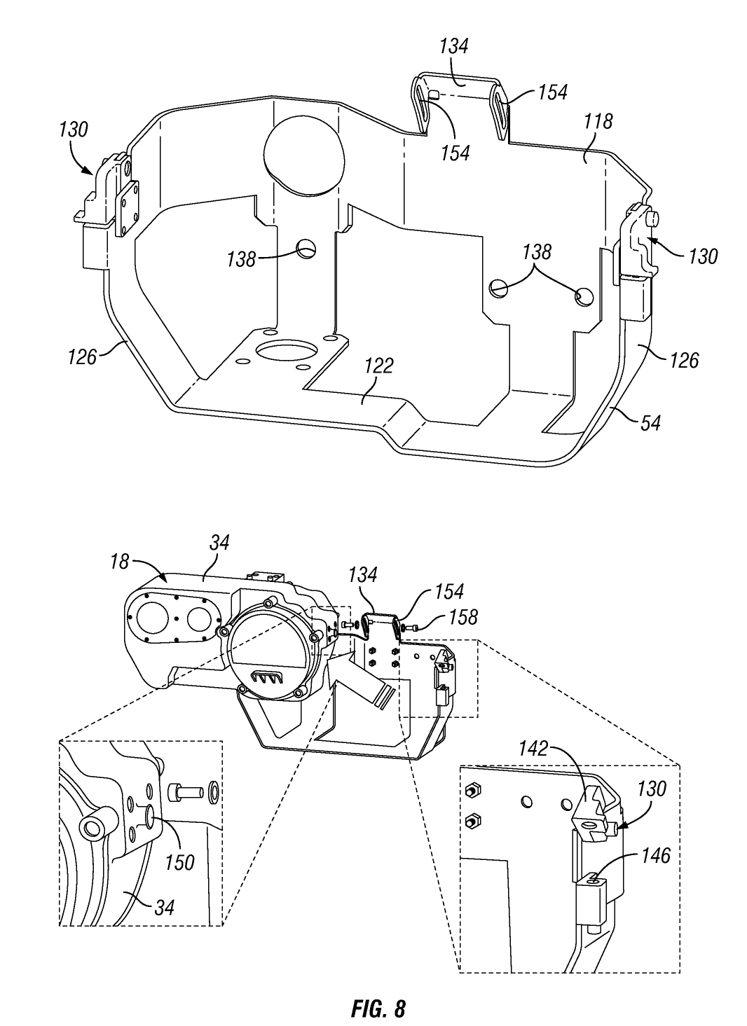

Referring now to FIG. 8 enlarged views are shown of mounting member 54 of FIG. 1, as well as certain features of housing 34 of imaging sensor module 18, of FIGS. 1 and 5. In the embodiment shown, mounting member 54 includes a rear portion 118, a bottom portion 122, side portions 126, side latching mechanisms 130, and an upper connection portion 134. Rear portion 118 comprises a plurality of holes 138 in a pattern to match existing holes in vehicle 14 (e.g., holes corresponding to screws 66 in FIG. 3) such that the mounting member is configured to be connected to the vehicle without permanently modifying the vehicle. In other embodiments, hole patterns that match existing screw holes on a vehicle can be formed in bottom portion 122, side portions 126, and/or rear portion 118. In some embodiments, rear portion 118 and/or bottom portion 122 can be provided with a plurality of holes that do not correspond to existing screw holes on a vehicle.

Latching mechanisms 130 are disposed on side portions 126. Each latching mechanism 130 comprises an arm 142 pivotally coupled to the respective side portion 126, and a screw 146 for securing arm 142 in a closed position. Each latching mechanism 130 is shaped or otherwise configured to pivotally couple to a corresponding structure on a lateral side of the imaging sensor module 18, such as, for example, an ear 150 having a body with an enlarged outer end. Upper connection portion 134 includes one or more arcuate slots 154 positioned concentrically about the pivotal center of latching mechanisms 130 (and ears 150). Arcuate slots 154 permit upper connection portion 134 to be connected to housing 34 of the imaging sensor module by screws 158. In this way, ears 150 can be coupled to side portions 126 by way of latching mechanisms 130, and screws 158 can be inserted through arcuate slots 154 and partially threaded into housing 34 without tightening the screws. The imaging sensor module can then be angularly adjusted and the screws tightened to secure the imaging sensor module relative to the mounting bracket.

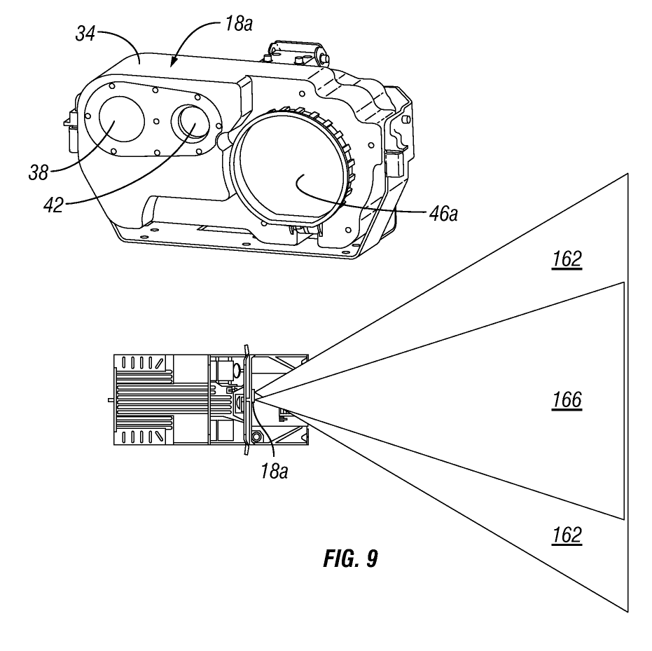

Referring now to FIG. 9, another embodiment of an imaging sensor module 18a is shown having a near-infrared (NIR) illuminator 46a (instead of marker light 46 of FIGS. 2 and 5), along with diagrams of the fields-of-view of NIR illuminator 46a and VNIR sensor 42. For example, the NIR illuminator can improve performance of the VNIR sensor. The NIR illuminator can be configured to emit any wavelength of infrared (IR). light, such as, for example 830 nanometers (nm). This can be advantageous, for example, for combat operations when visible light is not desired, because the near-IR light can effectively “illuminate” an area for the VNIR sensor while not emitting visible light that could be perceived by an enemy. As indicated in the diagram, in some embodiments, the NIR illuminator is configured to have a field-of-view or illumination area 162 that is greater than the field-of-view 166 of the VNIR sensor.

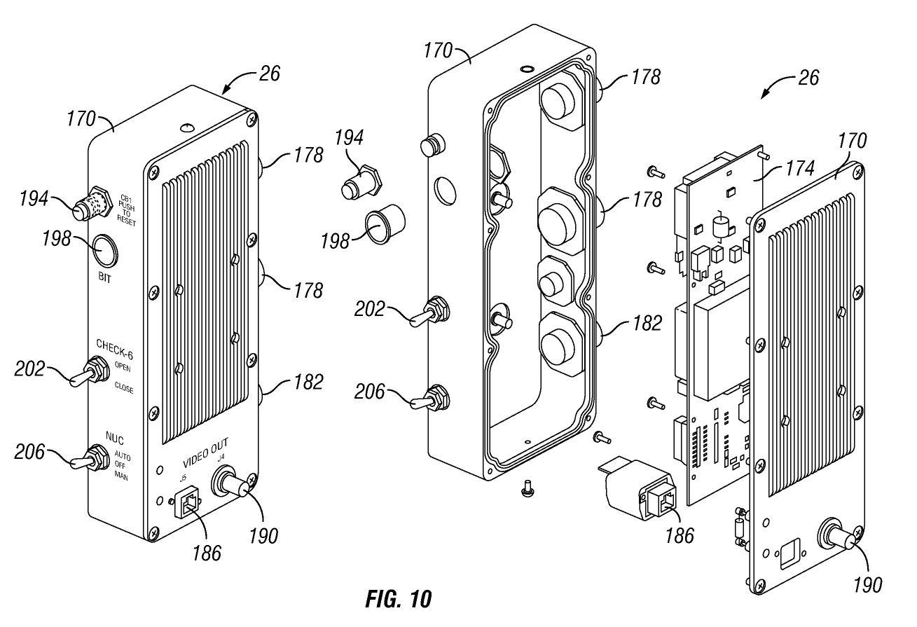

Referring now to FIG. 10, enlarged perspective and exploded views are shown of the central interface module 26 of FIG. 1. The central interface module (CIM) is configured to be coupled to the image-fusion board and to the display such that fused images can be transmitted from the image-fusion board to the display via the central interface module. In the embodiment shown, central interface module 26 is also configured to be coupled to one or more additional imaging devices (such as rear imaging device 30) such that images can be transmitted from the one or more additional imaging devices to the display via the CIM. In the embodiment shown, the central interface module comprises a housing 170, one or more circuit boards (or CCAs) 174, video input connections 178, a power input connection 182, a digital video output connection 186, and an analogue video output connection 190. The housing can comprise any suitably durable material, such as, for example, 6061 Aluminum, 7068 Aluminum, 7075 Aluminum, polymer, steel, alloy, composite, or the like. In the embodiment shown, the connections, e.g., 178, 182, 186, and 190 are hermetically sealed.

The one or more circuit boards (or CCAs) 174 and/or other portions of the central interface module are configured for a variety of functions, such as, for example, power conditioning; circuit-interrupt protection (circuit breaker); open/close control for a shutter, if any, of rear imaging device 30; power-on check for imaging sensor module 18 and/or rear imaging device 30; non-uniformity correction (NUC) control; built-in testing (BIT) functions; and the like. In the embodiment shown, these functions can be controlled by various switches. More specifically, a circuit breaker 194 provide circuit-interrupt protection to prevent damage from shorts, excess current, and the like; BIT switch 198 initiates built-in testing (BIT) functions; toggle switch 202 provides open/close control for a shutter, if any, of rear imaging device 30; and switch 206 is switchable between “auto”, “off”, and “manual” to designate the control mode for control for non-uniformity correction (NUC) functions.

In some embodiments, a non-uniformity correction (NUC) function normalizes or “zeroes” the pixels of the LWIR sensor, such as, for example, as it warms up or cools down. Since each pixel of the LWIR sensor detects thermal energy, the individual response of each pixel can very as the sensor heats up or cools down, and, in some cases, can affect image quality. By way of example, the LWIR sensor can be configured to zero or re-baseline the response of all the pixels in an array by dropping or introducing a shutter in the field-of-view of the LWIR sensor and then measuring the response of all the pixels. This response information can then processed and used to apply a bias to the resistance value of each individual pixel to ensure the response from them is uniform based on given scene (the shutter) and temperature. This shuttering can be done very quickly, e.g., less than a second, but may still create a noticeable “wink” and/or temporary loss of imagery on the display. In some embodiments, the one or more circuit boards 174 and/or the LWIR sensor 38 can be configured to perform the NUC function periodically, e.g., every 5, 10, 15, 30, 60 minutes. In some embodiments, the one or more circuit boards 174 and/or the LWIR sensor 38 can be configured to perform the NUC function periodically during only an initial period, e.g. 5, 10, 15, 30, 60, 90, 120 minutes, after an event, such as, for example, start-up, a temperature change greater than a change threshold (e.g., 5-degree change, 10-degree change), or the like. NUC delay switch 206 on the CIM allows a user to delay this the NUC function, such as, for example, during critical times when a loss of imagery is not desirable, and/or to initiate an immediate NUC function at a desirable time.

In some embodiments, the built-in testing (BIT) function is configured to run at an event, e.g., start-up, to check for one or more of, the function of (presence of images from) the two imaging sensors, power to system components such as the -fusion board, communication with major components such as the fusion board, and the like.

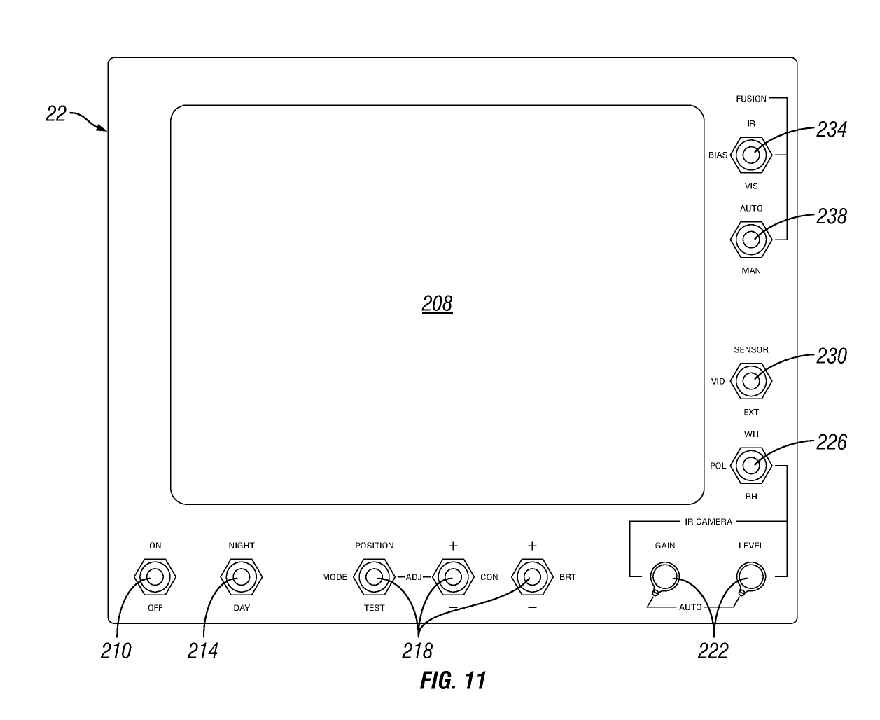

Referring now to FIG. 11, depicts a front view of display 22 of FIG. 4. The display is configured to be coupled to the image-fusion board such that the display can receive and display fused images from the image-fusion board. In the embodiment shown, display 22 comprises a screen 208, such as, for example, a liquid crystal display (LCD) screen for displaying fused images from the image-fusion board and/or images from the rear imaging device. One example of a suitable LCD is a military-qualified 800×600 10.5 inch monochromatic LCD display. In the embodiment shown, the display also comprises one or inputs such as switches. More specifically, display 22 comprises a system on/off switch 210; a day/night switch 214 for switching between a lower brightness level for night and a higher brightness level for day; display-specific controls 218, such as brightness, contrast, position, mode, and the like; gain and level controls 222 for the LWIR sensor; polarity controls 226 (white-hot, black-hot) for the LWIR sensor; and a sensor switch 230 for switching inputs between the front imaging sensor module 18 and the optional rear imaging device 30.

In the embodiment shown, the display further comprises an input device (e.g., switch 234), physically coupled to the display and configured to be coupled to the image-fusion board (e.g., by way of cables to the imaging sensor module). The switch 234 is configured to be operable by a user to adjust the intensity of images from the first imaging sensor (e.g., LWIR sensor 38) relative to the intensity of images from the second imaging sensor (e.g., VNIR sensor 42) in the fused images, as described above for the image-fusion board. Display 22 also comprises a switch 238 for selecting between manual and automatic control of the relative intensities of images from the LWIR sensor relative to images from the VNIR sensor. That is, when switch 238 is in “MAN” or manual position, switch 234 adjusts the relative intensities; but when switch 238 is in the “AUTO” or automatic position, switch 234 is disabled and one or more controllers in one or more of the display, central interface module, and imaging sensor module automatically controls the relative intensities of the images so as to, for example, optimize the clarity of the fused images for whatever light or other conditions are currently present.

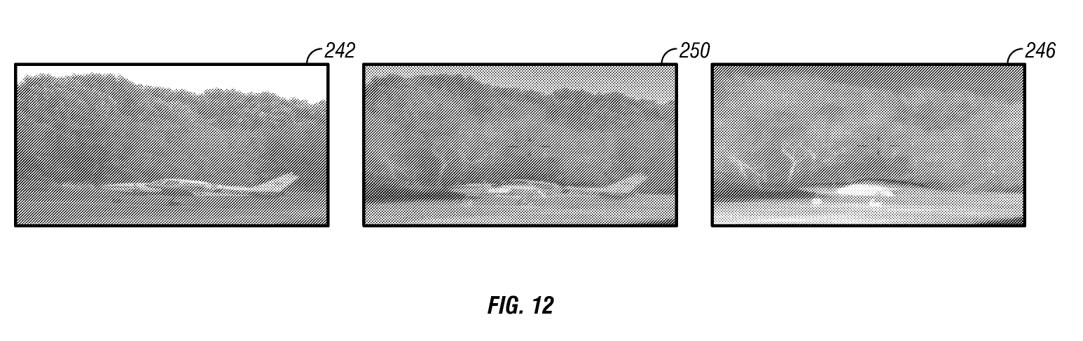

Referring now to FIG. 12, an image 242 from a VNIR sensor, an image 246 from a LWIR sensor, and a fused image 250 fused from the VNIR image and LWIR image are shown fused at about 50:50 relative intensities.

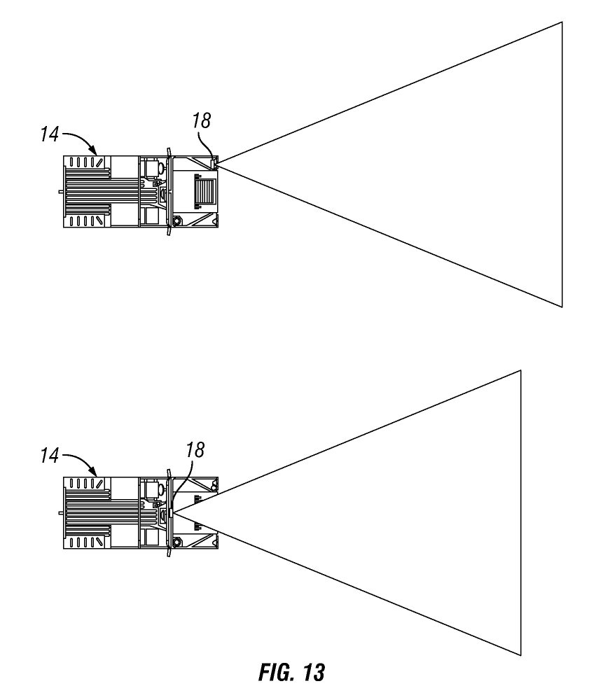

Referring now to FIG. 13, two exemplary mounting positions on a vehicle 14, such as a Humvee, are shown for an imaging sensor module 18. In configuration 254, shown above in FIG. 1, imaging sensor module 18 is mounted on the vehicle at a front corner of the vehicle, such as, for example, a front marker light location. In configuration 258, imaging sensor module 18 is mounted in a central location, such as, for example, the central windshield member of a Humvee, or the like.

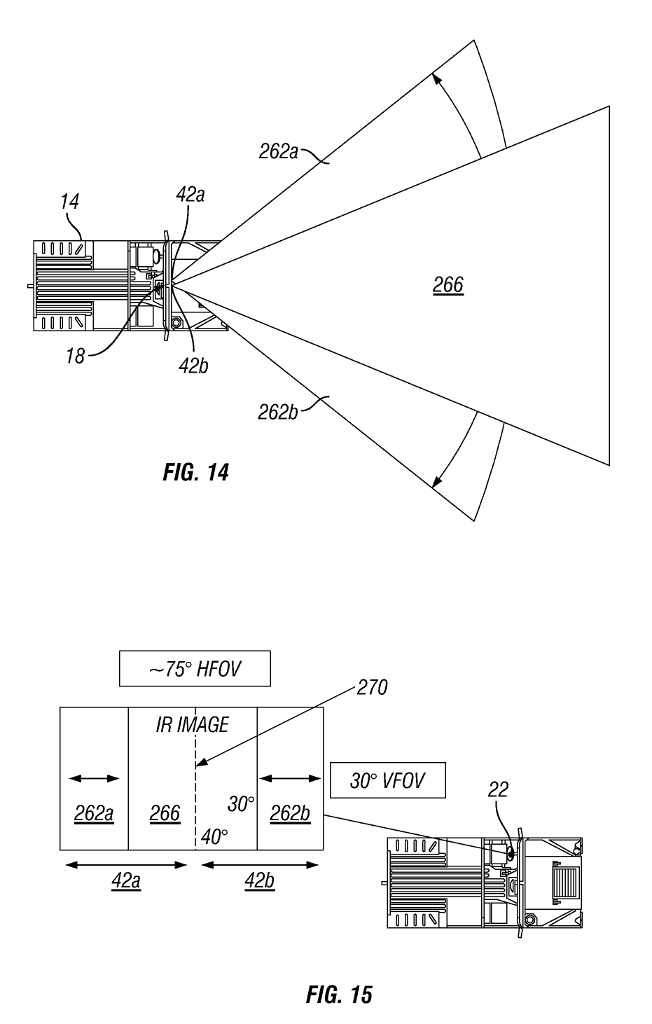

Referring now to FIGS. 14 and 15, possible field-of-view (FOV) configurations for embodiments of the present imaging systems in which the imaging sensor module includes two VNIR sensors and a single LWIR sensor. More specifically, a first VNIR sensor 42a has a field-of-view 262a that is about 40 degrees wide and about 30 degrees tall, and a second VNIR sensor 42b has a field-of-view 262b that is about 40 degrees wide and about 30 degrees tall. Additionally, the first and second VNIR sensors 42a and 42b are configured such that their fields-of-view overlap one another by approximately 5 degrees. These two fields-of-view can be digitally “stitched” together such that their combined field-of-view is about 75 degrees wide by about 30 degrees tall. The single LWIR sensor has a field-of-view 266 that is about 40 degrees wide and about 30 degrees tall, and that is centered on the central stitch line 270 of the VNIR fields-of-view 262a and 262b, and fused (e.g., by an image-fusion board, as described above) with the central 40 degrees of VNIR stitched field-of-view, as shown. In this way, the system 10 can be configured (e.g., by way of one or more of a user input, display, image-fusion board, and/or central interface module) to permit a user to select between display modes such as: (1) full viewport that includes the entire stitched/fused field-of-view viewable by a user, e.g., via the display; and (2) “cropped” viewport that includes only 40 degrees of the stitched and/or fused field-of-view (e.g., left 40 degrees such as when about to turn left, right 40 degrees such as when about to turn right, and/or center 40 degrees with entire field-of-view fused/fasable between VNIR and LWIR) viewable by a user, e.g., via the display.

In some embodiments, imaging sensor module 18 and/or mounting bracket 54 are configured to fit within a rectangular box having a height less than or between any of about 5.5 inches, 6 inches, 6.5 inches, 7 inches, or 7.5 inches; and/or a depth less than or between any of about 4 inches, 4.5 inches, 5 inches, 5.5 inches, or 6 inches; and/or a width less than or between any of about 8 inches, 9 inches, 10 inches, 10.5 inches, 11 inches, 11.5 inches, 12 inches, 12.5 inches, 13 inches, 14 inches, or 15 inches. In some embodiments, imaging sensor module 18 and/or mounting bracket 54 are configured to fit within a volume of less than or between any of about 300 cubic inches, 310 cubic inches, 320 cubic inches, 330 cubic inches, 340 cubic inches, 350 cubic inches, 360 cubic inches, 365 cubic inches, 370 cubic inches, 375 cubic inches, 380 cubic inches, 385 cubic inches, 390 cubic inches, 400 cubic inches, 410 cubic inches, 420 cubic inches, 430 cubic inches, 440 cubic inches, or 450 cubic inches.

The various illustrative embodiments of devices, systems, and methods described herein are not intended to be limited to the particular forms disclosed. Rather, they include all modifications, equivalents, and alternatives falling within the scope of the claims. For example, in embodiments, such as the ones depicted above, of the present imaging systems, the imaging sensor module could comprise the first imaging sensor and the second imaging sensor, and the display could comprise the image-fusion board, such that images from the first imaging sensor and images from the second imaging sensor could be received and fused at the display rather than at the imaging sensor module.

The claims are not intended to include, and should not be interpreted to include, means-plus- or step-plus-function limitations, unless such a limitation is explicitly recited in a given claim using the phrase(s) “means for” or “step for,” respectively.

What is claimed is:

1. An imaging system for use with a vehicle, the imaging system comprising:
a first imaging sensor;
a second imaging sensor; and
a housing coupled to the first imaging sensor and the second imaging sensor, the housing configured to be connected to a vehicle without permanently modifying the vehicle.

2. The imaging system of claim 1, where the first imaging sensor is a long-wavelength infrared (LWIR) sensor.

3. The imaging system of claim 2, where the second imaging sensor is a visible near-infrared (VNIR) sensor.

4. The imaging system of claim 1, further comprising:
an image-fusion board coupled to the first imaging sensor and the second imaging sensor, the image-fusion board configured to fuse images from the first imaging sensor with images from the second imaging sensor.

5. The imaging system of claim 3, further comprising:
a plurality of light-emitting diodes (LEDs) coupled to the housing.

6. The imaging system of claim 5, where the LEDs are configured to emit visible amber-colored light.

7. The imaging system of claim 5, further comprising
a blackout driving light coupled to the housing.

8. The imaging system of claim 1, further comprising:
a display configured to be coupled to the image-fusion board such that the display can receive and display fused images from the image-fusion board.

9. The imaging system of claim 8, further comprising:
an input device coupled to the image-fusion board, and configured to be operable by a user to adjust the intensity of images from the first imaging sensor relative to the intensity of images from the second imaging sensor in the fused images.

10. The imaging system of claim 9, where the input device is physically coupled to the display.

11. The imaging system of claim 1, further comprising:
a central interface module (CIM) configured to be coupled to the image-fusion board and to the display such that fused images can be transmitted from the image-fusion board to the display via the CIM.

12. The imaging system of claim 11, where the central interface module (CIM) is configured to be coupled to one or more additional imaging devices such that images can be transmitted from the one or more additional imaging devices to the display via the CIM.

13. The imaging system of claim 1, where the vehicle is selected from the group consisting of. M1117 Guardian Armored Security Vehicles (ASVs), High Mobility Multipurpose Wheeled Vehicles (Humvee), Family of Medium Tactical Vehicles (FMTV), Light Medium Tactical Vehicles (LMTV), Medium Tactical Vehicles (MTV), Medium Tactical Vehicle Replacements (MTVR), Heavy Expanded Mobility Tactical Trucks (HEMTT), Heavy. Equipment Transport Systems (HETS), Palletized Load System (PLS) vehicles, and Bradley Fighting Vehicles.

14. An imaging system for use with a vehicle, the imaging system comprising:
a long-wavelength infrared (LWIR) sensor configured to detect one or more infrared wavelengths of light;
a visible near-infrared (VNIR) sensor;
a plurality of light-emitting diodes (LEDs) configured to emit one or more near-infrared wavelengths of light that correspond to the one or more near-infrared wavelengths of light the VNIR sensor can detect; and
a housing coupled to the first imaging sensor, the second imaging sensor, and the plurality of LEDs, the housing configured to be connected to a vehicle.

15. The imaging system of claim 14, where the LEDs emit only non-visible light.

16. An imaging system configured for use with a vehicle, the imaging system comprising:
a long-wavelength infrared (LWIR) sensor;
a visible near-infrared (VNIR) sensor;
a plurality of light-emitting diodes (LEDs);
a housing coupled to the LWIR sensor, the VNIR sensor, and the plurality of LEDs, the housing configured to be connected to a vehicle.

17. The imaging system of claim 16, further comprising:
a blackout driving light.

18. The imaging system of claim 16, further comprising:
an image-fusion board coupled to the LWIR sensor and the VNIR sensor, and configured to fuse images from each of the LWIR sensor and the VNIR sensor.

19. A vehicle having an imaging system, comprising:
a vehicle having a front axle; and
an imaging system comprising:
a long-wavelength infrared (LWIR) sensor; and
a visible near-infrared (VNIR) sensor;
where the LWIR sensor and the VNIR sensor are coupled to the vehicle and disposed in front of the front axle of the vehicle.

20. The vehicle of claim 19, further comprising:
an image-fusion board coupled to the LWIR sensor and the VNIR sensor, and configured to fuse images from each of the LWIR sensor and the VNIR sensor; and

21. The vehicle of claim 20, further comprising:
a display coupled to the image-fusion board and configured to receive fused images from the image-fusion board and displaying the fused images in a format perceivable by a user;

22. The vehicle of claim 19, where the vehicle is selected from the group consisting of: M1117 Guardian Armored Security Vehicles (ASVs), High Mobility Multipurpose Wheeled Vehicles (Humvee), Family of Medium Tactical Vehicles (FMTV), Light Medium Tactical Vehicles (LMTV), Medium Tactical Vehicles. (MTV), Medium Tactical Vehicle Replacements (MTVR), Heavy Expanded Mobility Tactical Trucks (HEMTT), Heavy Equipment Transport Systems (HETS), Palletized Load System (PLS) vehicles, and Bradley Fighting Vehicles.

23. An imaging system for use with a vehicle, the imaging system comprising:
a long-wavelength infrared (LWIR) sensor;
a visible near-infrared (VNIR) sensor; and
a housing coupled to the LWIR sensor and the VNIR sensor;
where one of the LWIR sensor and VNIR sensor is coupled to the housing in fixed relation to the housing, and where the other of the LWIR sensor and VNIR sensor is adjustably coupled to the housing.

24. The imaging system of claim 23, further comprising:
an adjustment mechanism coupled to each of the housing and the adjustably-coupled one of the LWIR sensor and VNIR sensor such that the adjustably-coupled one of the LWIR sensor and VNIR sensor is coupled to the housing via the adjustment mechanism, the adjustment mechanism configured to permit adjustment of the position of the adjustably-coupled one of the LWIR sensor and VNIR sensor relative to the housing.

25. The imaging system of claim 24, where the adjustment mechanism comprises:
a pivot plate coupled to the adjustably-coupled one of the LWIR sensor and VNIR sensor;
a plurality of adjustment posts, each coupled to the housing and to the adjustment plate;
where the pivot plate and adjustment posts are configured to permit a user to adjust the position of the pivot plate relative to one or more of the adjustment posts to adjust the position of the adjustably-coupled one of the LWIR sensor and VNIR sensor relative to the housing.
